(19) United States
(12) Patent Application Publication
(10) Pub. No.: US 2024/0162470 A1
(43) Pub. Date: May 16, 2024

(54) BATTERY CELL FOR A MOTOR VEHICLE, SYSTEM OF A BATTERY CELL AND A MOUNTING DEVICE, AND METHOD FOR MANUFACTURING A BATTERY CELL

(71) Applicant: Volkswagen Aktiengesellschaft, Wolfsburg (DE)

(72) Inventor: Tobias ABEL, Braunschweig (DE)

(73) Assignee: Volkswagen Aktiengesellschaft, Wolfsburg (DE)

(21) Appl. No.: 18/388,258

(22) Filed: Nov. 9, 2023

(30) Foreign Application Priority Data
Nov. 10, 2022 (DE) 10 2022 211 930.4

(51) Int. Cl. H01M 10/04; H01M 50/103

(52) U.S. Cl. CPC H01M 10/0404; H01M 10/049; H01M 50/103; B60R 16/033; H01M 2220/20

(57) ABSTRACT

A battery cell for a motor vehicle, having a battery cell housing having an insertion opening and at least one cell stack to be inserted into the battery cell housing, and drive coupling structures in the form of elevations and/or indentations extending transversely to the insertion direction being formed on at least one outer side of the cell stack. A system is also provided for a mounting device with at least one drive roller for inserting a cell stack into a battery cell housing of a battery cell. The drive roller having roller coupling structures distributed over the circumference, which are designed to be complementary to the coupling structures on the battery cell package. Also, a method for inserting a cell stack is provided.

This nonprovisional application claims priority under 35 U.S.C. § 119(a) to German Patent Application No. 10 2022 211 390.4, which was filed in Germany on Nov. 10, 2022, and which is herein incorporated by reference.

### BACKGROUND OF THE INVENTION

### Field of the Invention

The invention relates to a battery cell for a motor vehicle, a system of a battery cell and mounting device, and a method for inserting a battery cell package into a battery cell housing.

### Description of the Background Art

A battery module for a motor vehicle and a method for the manufacturing thereof are known from DE 10 2019 109 715 A1. The battery module comprises a battery module housing with an insertion opening and at least one battery cell package. The battery cell package includes at least two battery cells, arranged in parallel to each other, and at least one compression pad arranged in parallel to the battery cells. The battery cell package also includes at least two insertion auxiliary layers, which each form opposite outer sides of the cell stack in the thickness direction. According to the method, the battery cell package is compressed with the aid of cylindrical rollers in the thickness direction and inserted into the battery module housing. Details about the structure of the battery cells installed in the battery modules as well as the manufacture thereof are not disclosed.

The invention relates to battery cells, which may be designed structurally in a manner similar to the battery modules described above, the illustrated battery cells then being individual cell stacks, which are each formed from an anode, cathode, and separator. A compression pad is not absolutely necessary for the battery cells according to the invention. In particular, the invention deals with the insertion of cell stacks, which include deflector tabs protruding from the battery cell package in the insertion direction, or which are to experience as little pressure load as possible for other reasons on the insertion back side opposite the insertion front side. The battery cell packages may be not inserted completely into the battery cell housing with the aid of the method described from the prior art mentioned above, or the re-insertion is associated with the risk that the battery cell package or an element protruding from the battery cell package, such as a deflector tab, becomes damaged by a pressure load on the insertion back side during the insertion of the cell stack.

### SUMMARY OF THE INVENTION

The object of the invention is to provide a battery cell for a motor vehicle, a system of a battery cell and mounting device, and a method for inserting a battery cell package into a battery cell housing, with the aid of which a secure insertion of the cell stack into the battery cell housing is made possible.

The object is achieved according to the invention by the features of the independent claims. Additional practical specific embodiments and advantages of the invention are described in connection with the dependent claims.

A battery cell according to an exemplary embodiment of the invention for a motor vehicle comprises a battery cell housing with an insertion opening and at least one battery cell package to be inserted into the battery housing. A battery cell package within the meaning of the invention may be made up of only one single battery cell. However, within the meaning of the invention, what is meant by a battery cell package is a stack of at least two battery cells, which are arranged in parallel to each other and thus form a cell stack. In a battery cell according to the invention, drive coupling structures in the form of elevations and/or indentations extending transversely to the insertion direction are formed on at least one outer side of the cell stack. In particular, circular or polygonal openings or knobs are meant thereby. However, groove-like indentations or rib-like structures protruding from the battery cell package are also understood to be coupling structures within the meaning of the invention. Coupling structures are furthermore all other structures which are suitable for permitting a form-fitting driving of the cell stack for insertion into the battery cell housing in connection with a drive roller, which has complementary roller coupling structures. As explained below in connection with the dependent claims, a battery cell according to the invention makes it possible to insert a battery cell package into a battery cell housing securely and without damaging the insertion front side and insertion back side, regardless of its design in the region of the insertion front side and insertion back side.

At least one insertion auxiliary layer can be formed on the outside of the battery cell package, the coupling structures being formed on the at least one insertion auxiliary layer. Two insertion auxiliary layers are preferably provided on two opposite outer sides of the cell stack. The formation of coupling structures on one or multiple insertion auxiliary layers has the advantage that the insertion auxiliary layers may be manufactured separately, and the insertion auxiliary layers may be connected to the battery cell package only shortly before the insertion into the battery cell housing. In addition, there is also no danger in this case of the battery cell package becoming damaged during the formation of coupling structures, in particular indentations or elevations. An insertion auxiliary layer may also be easily connected, in particular by gluing, lamination, seaming, flanging, or in another manner.

In a further practical specific embodiment of the battery cell according to the invention, the at least one insertion auxiliary layer can be designed as a guide rail, which is fixedly connected to the battery cell package. A guide rail in this connection is understood to be, in particular, an essentially dimensionally stable element, which may be flexible and yet have a sufficient inherent stiffness to be able to take into account the functions explained. In particular, plastic, preferably thermoplastic plastic, is suitable as the material for the guide rail. However, the guide rails may also be manufactured from another arbitrary material. With respect to the insertion auxiliary layer, in particular the preferable arrangement on two opposite outer sides of the cell stack, the above also applies similarly to insertion auxiliary layers designed as a guide rail.

The at least one guide rail may have a projection over the length of the cell stack on the insertion back side. In this connection, the length of the cell stack can be understood to be the back end of the battery cells themselves. The length of the cell stack does not include any deflector tabs, which protrude toward the rear over the battery cells in the insertion direction. The projection of the at least one guide rail over the battery cell package is preferably selected to be of the same size as possible elements, in particular deflector tabs, protruding over the battery cell package in the insertion direction. This has the advantage that the protruding elements are protected by the guide rails, in particular when a force acts upon the battery cell package over a wide area from the insertion back side.

A predetermined breaking point can be formed on the guide rail. A predetermined breaking point of this type may be used to separate the projection of a guide rail, which is no longer needed, after a cell stack has been completely inserted into the battery cell housing and to remove it from the battery cell package.

A plurality of openings can be designed as coupling structures, which are arranged at regular intervals, viewed in the insertion direction. This makes it possible to drive battery cell modules with the aid of a drive roller, which has corresponding roller coupling structures at regular intervals.

If a first opening in the region of the insertion front side is designed as an elongated hole, or if the openings of a first row in the region of the insertion front side are designed as elongated holes, a tolerance compensation may be provided with the aid of the elongated holes for the first coupling of a cell stack to a drive roller of a mounting device. This increases the failure tolerance and thus the functional reliability during the mounting of a battery cell according to the invention.

Further advantages arise if the one elongated hole or the multiple elongated holes has/have a widened coupling region with an enlarged opening in a partial region, in particular in an initial region, and if the opening is designed to taper in the direction of an end region. In this case, greater length and/or width deviations in the relative position between a drive roller and the corresponding outer side of the cell stack, in particular an insertion auxiliary layer with indentations, may be compensated for during the first contact between the coupling structures of the drive roller, in particular in the form of knobs, and the openings in the outer side of the cell stack during the first engagement of the knobs with a battery cell package or an insertion auxiliary layer of a cell stack. This makes it possible for the knob(s) to dip into the partial region having the enlarged opening and to subsequently generate a setpoint relative position between the drive roller and the battery cell package, forced by the geometry of the opening, due to the relative movement of the knob within the opening. The opening/openings of the first row in the region of the insertion front side is/are used in this case as an optimized centering and relative positioner between the drive roller and the battery cell package.

The invention also relates to a system of a mounting device with at least one drive roller for inserting a cell stack into a battery cell housing of a battery cell as described above. The drive roller has roller coupling structures distributed over the circumference, which are designed to be complementary to the coupling structures on the battery cell package. A drive roller within the meaning of the system according to the invention is understood to be, in particular, a cylindrical drive roller, which has knobs protruding radially from the roller as roller coupling structures.

The roller coupling structures can be arranged to be extendable from the drive roller in such a way that the extension of the roller coupling structures is controllable with the aid of a suitable coupling structure drive, depending on the particular position of the drive roller. The coupling structure drive may be driven, in particular, pneumatically, hydraulically, and/or electrically.

The coupling structure drive can have two extension positions, in particular a first extension position for interacting with the coupling structures formed on the battery cell package, and a second extension position for separating a projection of a guide rail, in particular a guide rail on which a predetermined breaking point is formed.

The invention also relates to a method for inserting a cell stack into a battery cell housing described above with the aid of a mounting device, which includes a rotatably supported drive roller having roller coupling structures. The roller coupling structures interact with the coupling structures formed on the battery cell package during the rotation of the drive roller in such a way that the battery cell package is inserted into the battery cell housing in a form-fitting manner. Reference is hereby made to the advantages already described above in connection with the battery cell according to the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a battery cell according to the invention, including a battery cell housing and a battery cell package to be inserted into the battery cell housing prior to mounting, in a view from the side;

FIG. 2 shows the battery cell from FIG. 1 in a top view, prior to mounting;

FIG. 3 shows an alternative specific embodiment of a cell stack of a battery cell according to the invention in a view from the side, including a back-side projection of a guide rail and including optimized centering components in the region of the insertion front side;

FIG. 4a shows the guide rail of the battery cell package illustrated in FIG. 3 in a side view prior to the separation of the projection;

FIG. 4b shows the guide rail from FIG. 4a after the separation of the projection in the region of the predetermined breaking point;

FIG. 5 shows a drive roller, including roller coupling structures in the form of extendable knobs and a pneumatic or hydraulic drive;

FIG. 6 shows a detailed representation of a single knob of the drive roller illustrated in FIG. 5; and

FIG. 7 shows an alternative design of a drive roller, similar to the drive roller illustrated in FIG. 5, including an electromagnetic drive.

### DETAILED DESCRIPTION

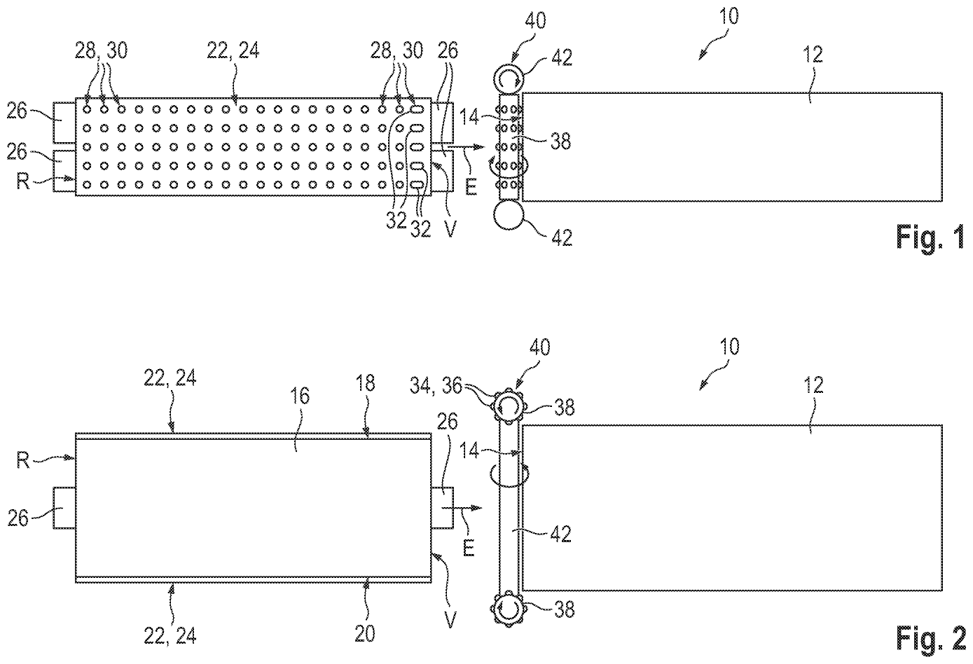

An as yet unmounted battery cell 10 is shown in FIGS. 1 and 2 in a view from above (FIG. 1) and in a side view (FIG. 2). Battery cell 10 comprises a battery cell housing 12 with an insertion opening 14. Battery cell 10 furthermore comprises a battery cell package 16, which is illustrated in simplified form as a rectangle in FIG. 2. In the illustrated specific embodiment, insertion auxiliary layers 22 in the form of guide rails 24 are formed on two opposite outer sides 18, 20 of cell stack 16. They extend over the entire length of cell stack 16 in the specific embodiment shown in FIGS. 1 and 2. The goal is to insert battery cell package 16 securely into battery cell housing 12 in insertion direction E.

As is apparent in FIGS. 1 and 2, battery cell package 16 includes deflector tabs 26 protruding in the insertion direction in the region of insertion front side V as well as in the region of insertion back side R. If an insertion force were to be applied to insertion back side R for the purpose of inserting battery cell package 16 into battery cell housing 12, the danger would arise of deflector tabs 26 in the region of insertion back side R becoming damaged.

As is clearly apparent in FIG. 1, a multiplicity of coupling structures 28 in the form of round openings 30 are formed on guide rail 24. Openings 30 are provided with a predominantly circular design and arranged in rows of multiple openings 30, five as an example in this case. The front-most row of openings 30, viewed from insertion front side V, is not provided with a circular design but instead has elongated holes 32.

Coupling structures 28 formed on the outside of guide rails 24 permit an interaction with roller coupling structures 34 in the form of knobs 36, which are formed on drive rollers 38 of a mounting device 40.

It is explicitly noted that, as an alternative to illustrated knobs 36, helical drive couplings may also be provided as roller coupling structures 34. In particular, structures are to be understood thereby which engage with grooves on the guide rail from a driven shaft with the aid of a worm gear wheel. Structures of this type are not illustrated in the figures.

As is apparent in FIG. 2, knobs 36 serving as roller coupling structures 34 are arranged to be extendable from particular drive roller 38 in such a way that the extension of roller coupling structures 34 is controllable, depending on the particular position of drive roller 38. In the exemplary embodiment shown in FIGS. 1 and 2, knobs 36 are extended from drive roller 38 into the circumferential section, in which knobs 36 do not collide with battery cell housing 12. This makes it possible for knobs 36, which engage with openings 30 formed in guide rails 24, to establish a form-fitting connection between particular drive roller 38 and guide rail 24 and thus be inserted into insertion openings 14 of battery cell housing 12 due to the rotation of drive rollers 38 in the direction of arrow P of cell stack 16.

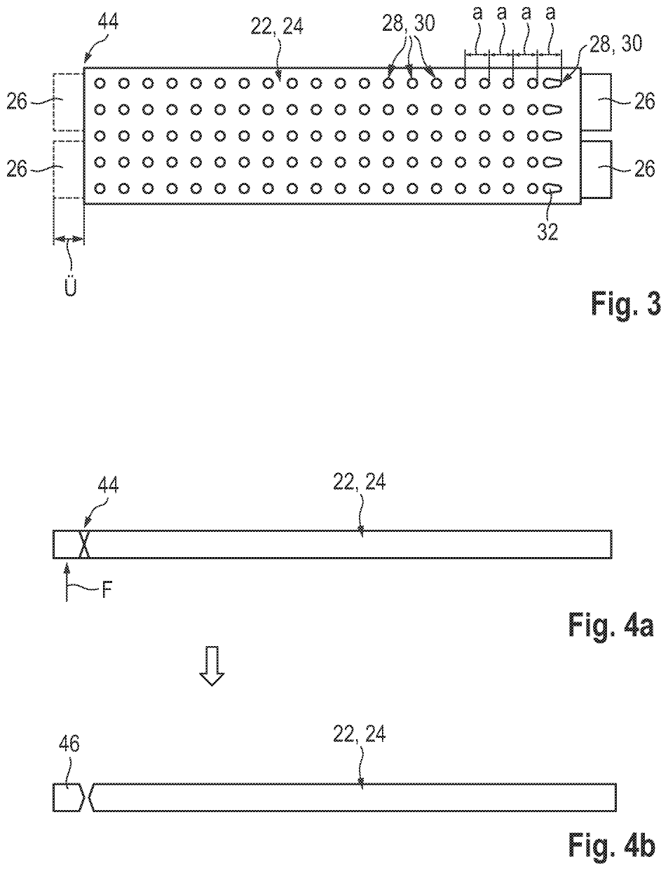

FIG. 3 shows an alternative specific embodiment of a cell stack 16, in which a guide rail 24 having a projection Ü is used. Projection Ü is selected to be larger than the length of deflector tabs 26 extending in insertion direction E, which are shown to be covered by guide rail 24 in FIG. 3 and therefore by dashed lines. Due to projection Ü, deflector tabs 26 are therefore protected against the action of forces acting upon insertion back side R, since forces of this type would be absorbed by guide rails 24.

FIG. 3 also shows that the distance between the individual rows of openings 30 amounts to a in each case and is the same size in each case from row to row. This also applies to the distance between the first row having elongated holes 32 and the second row, starting at which openings 30 are provided with a circular design.

In the specific embodiment illustrated in FIG. 3, openings 30 are designed as keyhole-shaped elongated holes 32. The left-side end is designed as a partial region having an enlarged opening, and the right-side end is dimensioned just like the right half of all remaining openings 30 in each case.

In the specific embodiment of guide rail 24 illustrated in FIG. 3, a predetermined breaking point 44 is additionally formed in the region of insertion back side R, approximately where battery cell package 16 end without taking deflector tabs 26 into account.

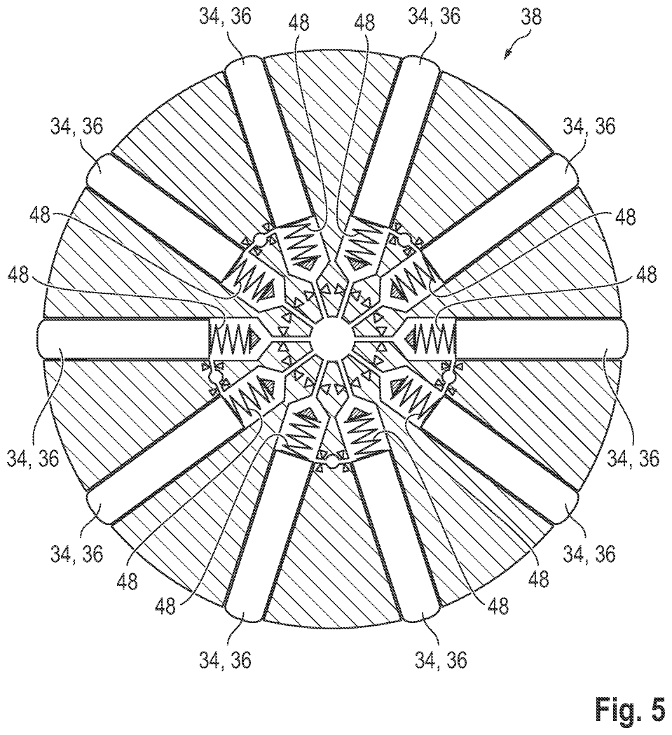

Predetermined breaking point 44 is clearly apparent in FIGS. 4a and 4b. FIG. 4a shows guide rail 24 prior to the separation and application of a force F onto the end-side section of guide rail 24. FIG. 4b shows guide rail 24 after the separation of an end section 46 of guide rail 24.

FIG. 5 shows an exemplary embodiment of a drive roller 38. In the illustrated specific embodiment, drive roller 38 comprises a total of ten roller coupling structures 34 in the form of knobs 36, which are extendable radially from drive roller 38. Knobs 36 are distributed evenly over the circumference. In the illustrated specific embodiment, a spring 48 in the relaxed state is arranged radially on the inside of each knob 36, an end of spring 48 being fixedly connected to the particular radial end of knob 36.

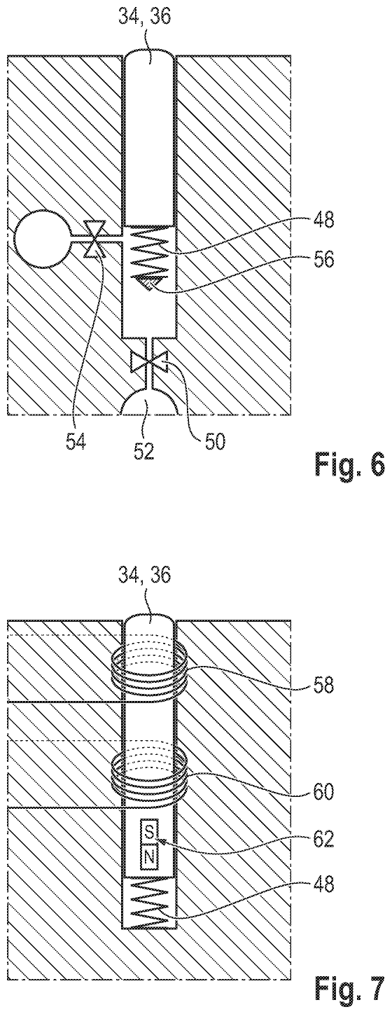

The driving of particular knobs 36 is described below with the aid of FIG. 6, based on the example of one knob 36. To extend knob 36 illustrated in FIG. 6, pressure is released from an overpressure fluid reservoir 52 in the direction of the radially inner end of knob 36 by driving an electronically controlled inlet valve 50. Knob 36 is extended thereby radially from drive roller 38. The pressure acting upon knob 36 radially to the inside may be decreased again via an electronically controlled outlet valve 54 in order to move knob 36 back into the retracted position illustrated in FIG. 6 by the action of spring 48. For this purpose, spring 48 is mechanically connected to a suitable element 56 radially on the inside, in order to tension spring 48 by the extension of knob 36.

FIG. 7 shows an alternative specific embodiment of knobs 36 of a drive roller 38. In this specific embodiment, a first coil 58 is provided radially on the outside, and a second coil 60 is provided radially further to the inside. A permanent magnet 62 is also integrated into knob 36 or fixedly connected thereto. A spring 48 is also provided in this specific embodiment, which is arranged radially on the inside of knob 36, which, in turn, is fixedly connected to drive roller 38 radially on the inside and is fixedly connected to the radially inside end of knob 36 radially on the outside.

By driving radially outside coil 58, particular knob 36 may be extended into a first position, which serves to interact with openings 30 formed in guide rails 24 for the purpose of insertion into a battery cell housing 12.

By driving coil 60 arranged radially on the inside, particular knob 36 may be moved into a further extended position, in particular, to separate an end section 46 of a guide rail 24, which has a predetermined breaking point 44 illustrated, for example, in FIGS. 4a and 4b, after corresponding battery cell package 16 has been inserted completely into battery cell housing 12.

For the sake of completeness, it is further noted that additional drive rollers 42 are provided in FIGS. 1 and 2, which may be optionally formed on a mounting device 40 to also apply additional insertion forces to the surfaces of cell stack 16 not provided with guide rails 24, or to ensure a side positioning of cell stack 16 relative to battery cell housing 12. Instead of these additional drive rollers 42, hopper-like positioning devices may also be provided, since a sufficiently great form-fitting force transfer is generated for insertion into battery cell housing 12 with the aid of the form-fitting driving by knobs 36 of the two drive rollers 38.

In addition, side and upper surfaces may be exchanged in a further specific embodiment, so that FIG. 1 relates to the top view and FIG. 2 to a side view.

In a design of elongated holes 32 shown in FIG. 1, only deviations of the relative position of knobs 36 and openings 30 may essentially be compensated for during the initial contact in insertion direction E.

In a design of elongated holes 32 shown in FIG. 3, deviations of the relative position of knobs 36 and openings 30 may be compensated for in the width direction (transversely to insertion direction E) as well as in insertion direction E during the initial contact.

The features of the invention disclosed in the present description, in the drawings and in the claims may be essential to implementing the invention in its various specific embodiments, both individually and in any combination. The invention may be varied within the scope of the claims and taking into account the knowledge of the competent person skilled in the art.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery cell for a motor vehicle, the battery cell comprising:
a battery cell housing with an insertion opening;
at least one battery cell package adapted to be inserted into the battery cell housing; and
at least two drive coupling structures structured as elevations and/or indentations extending transversely to an insertion direction are formed on at least one outer side of the battery cell package.

2. The battery cell according to claim 1, wherein at least one insertion auxiliary layer is formed on an outer side of the battery cell package, and wherein the coupling structures are formed on the at least one insertion auxiliary layer.

3. The battery cell according to claim 2, wherein the at least one insertion auxiliary layer is a guide rail, which is fixedly connected to the battery cell package.

4. The battery cell according to claim 3, wherein the at least one guide rail has a projection over a length of the cell stack on an insertion back side.

5. The battery cell according to claim 3, wherein a predetermined breaking point is formed on the guide rail.

6. The battery cell according to claim 1, wherein a plurality of openings are designed as coupling structures, which are arranged at regular intervals, viewed in an insertion direction.

7. The battery cell according to claim 1, wherein a first opening in a region of an insertion front side is designed as an elongated hole, or wherein openings of a first row in the region of the insertion front side are designed as elongated holes.

8. A system of a mounting device comprising at least one drive roller for inserting a cell stack into a battery cell housing of the battery cell according to claim 1, wherein the drive roller has roller coupling structures distributed over a circumference, which are designed to be complementary to the coupling structures on the battery cell package.

9. The system according to claim 1, wherein the roller coupling structures are arranged to be extendable from the drive roller such that the extension of the roller coupling structures is controllable via a suitable coupling structure drive, depending on a particular position of the drive roller.

10. A method for inserting a battery cell package into the battery cell housing according to claim 1, the method comprising:
providing a mounting device that includes a rotatably supported drive roller having roller coupling structures; and
inserting the battery cell package into the battery cell housing in a form-fitting manner, wherein the roller drive structures interact with coupling structures formed on the battery cell package during the rotation of the drive roller.
